(19) United States
(12) Patent Application Publication
(10) Pub. No.: US 2012/0079084 A1
(43) Pub. Date: Mar. 29, 2012

(54) LOCATION DEPENDENT CNNECTIVITY SETTINGS FOR TERMINAL DEVICES

(75) Inventors: Mika Forssell, Soderkulla (FI); Janne Juhani Parantainen, Helsinki (FI)

(73) Assignee: Nokia Siemens Networks Oy, Espoo (FI)

(21) Appl. No.: 13/260,284

(22) PCT Filed: Mar. 30, 2009
(86) PCT No.: PCT/EP2009/053735

§ 371 Date: Dec. 6, 2011

(51) Int. Cl. G06F 15/177

(52) U.S. Cl. 709/221

(57) ABSTRACT

A method of providing connectivity settings to a terminal device includes the steps of:

(i) detecting an indication about the terminal device being at a detected location other than an expected home location for the terminal device; and
(ii) sending connectivity settings to the terminal device which are appropriate to the detected location.

In one variant of the invention, detection occurs as a result of a travel plan notification that the terminal device is planned to be away from the home location. In another variant, detection occurs by determining that the terminal device is, in fact, away from the home location.

This invention relates to providing connectivity settings to terminal devices. It is particularly, but not exclusively, related to providing connectivity settings to wireless terminal devices.

As it becomes more common for employees of businesses to spend time travelling and yet still need access to data resources such as email, the Internet, and company/enterprise Intranets, businesses are also increasingly looking for ways to reduce the costs of providing such access, or connectivity, and make it more straightforward.

It is desirable for employees of a company, when travelling, to have connectivity and service settings which are suitable for application locally at destinations. Accordingly, employees typically need to find local connectivity and service settings when travelling, and then manually configure them into use. This can be laborious. Furthermore, for some employees, this task can prove difficult. As a result, in some cases, when travelling, employees may opt to use cellular connections (in the case of travelling abroad these may be roaming cellular connections) to make circuit-switched calls and transmit data, even though local WLAN connectivity may be available. It is often preferred for employees to use WLAN connectivity, provided via their employer's sites of business, to access their company Intranet, synchronize email, and to make and receive telephone calls, for example by using voice over IP (VoIP). In many cases, it is also preferred for employees to use publicly provided WLAN connectivity instead of cellular connectivity, such as that provided by a visited network or by another access provider. If cellular connections are used unnecessarily, this can incur otherwise avoidable costs made during travelling and the quality or quantity of work performed by employees may be adversely affected since getting connected can be complicated and may result in low quality or low speed connections, for example when using congested 2G or 3G cellular networks.

In an example case, an employee of a company makes a business trip to an office of his company in a foreign country. In such a case, the employee will not be able to access their Home Public Land Mobile Network (HPLMN). When the employee (device user) arrives in the foreign country, he turns on a wireless terminal device, for example a converged mobile telephone/email terminal device provided with cellular connectivity, at the destination airport. In some cases, for example when there is no partner of the terminal device user's home network operator, the wireless device may select a Visited Public Land Mobile Network (VPLMN) more or less randomly. As a result, the user is able to make voice calls and send and receive SMS messages. However, when trying to synchronize email, the wireless terminal device may give an error message, for example “Connection failed”. This could be due to there being no authorisation in place for data transfer while roaming provided by the terminal device user's home network operator which would permit data transfer via the selected VPLMN operator. In order to obtain the desired data connectivity, the terminal device user may need to open up a manual PLMN selection tool in the wireless terminal device and try various of the VPLMNs which are indicated as being available until one is found which enables data transfer.

This is not a user friendly approach. In addition, it is quite possible that in many cases an employee-selected VPLMN does not represent the network which would incur the lowest costs for the employer.

Other problems may be encountered. When the terminal device user goes to the company's local office, it may be the case that settings which are required to access the company Intranet locally, for example settings which are necessary to obtain WLAN connectivity, are not present in the terminal device or known by the terminal device user. This also can act as a deterrent to the terminal device user using a local area connection and instead they may use costly cellular roaming for activities such as synchronizing email or downloading files from an Intranet. Even if the user is willing to able to find out the necessary settings this means that they have to spend time doing so.

There are services in existence which help facilitate mobile connectivity. One such is the iPassConnect™ mobility service. This service has a mobility manager having a database of pre-identified access points around the world. On being launched, it recognises detected access points and refers to a large database in order to facilitate connections being made through various access networks for terminal device users who are travelling. This solution however provides only settings for connecting through whichever different networks might be available which have agreements with iPassConnect™, without for example considering which networks would be preferred over other networks which might be available.

According to a first aspect of the invention there is provided a method of providing connectivity settings to a terminal device comprising the steps of:

(i) detecting an indication about the terminal device being at a detected location other than an expected home location for the terminal device; and
(ii) sending connectivity settings to the terminal device which are appropriate to the detected location.

Preferably, the home location refers to the terminal device being in a network to which it has a subscription and/or access rights. It may be a cellular network for which the terminal device has a subscription. It may be a company or enterprise network or geographically identifiable part thereof which restricts access to terminal devices of qualifying individuals, for example individuals who are employees of a company or an enterprise. It may be a company or an enterprise Intranet. The detected location may be a cellular network for which the terminal device does not have a subscription but is able to use as a result of a roaming agreement. It may be a company or an enterprise network for which the terminal device has the right of access but for which it may not have optimally configured, or indeed any, connectivity settings.

Preferably the connectivity settings are sent from a network element. The network element may be a terminal management server. The network element may be located within and/or under the control of a network operator. Alternatively, it may be under the control of a company or an enterprise which is separate from the network operator. It may be a company or an enterprise for which a network operator provides communication services.

Preferably, the connectivity settings include settings in respect of a connectivity type which is different to the connectivity type via which the terminal device communicates with a network element in receiving the connectivity settings. The connectivity settings may include settings in respect of a connectivity type which is the same as the connectivity type via which the terminal device communicates with a network element in receiving the connectivity settings. Preferably, the connectivity settings which are sent replace and/or enhance non-optimum settings. The connectivity types may include WiMAX, cellular, long term evolution (LTE), wired IP, wide area network, and local area network. They may, for example, be for a local area network accessed over a local wireless connection such as wireless LAN. In one example, the connectivity settings may comprise settings appropriate for gaining access to an access point in a particular office location to be used in preference to connectivity settings for another office location, or other access point, already present in the terminal device. Preferably, the connectivity settings are specific to a company or enterprise. They may relate to gaining access to a company or an enterprise Intranet. They may relate to a preferred provider of communications services.

Different connectivity types may have different protocols, for example a cellular network connectivity type may operate according to protocols within, for example, the GSM (Global System for Mobile communications) system and WCDMA (Wideband Code Division Multiple Access) system, and a wired network may operate according to internet protocol (IP) and other protocols.

There may be different instances of the same type of connectivity settings. For example, there may be connectivity settings which all apply to WLAN access points, with some being corporate Intranet access points, some being suitable for public access points, and some being suitable for network operator-controlled access points. They may be some connectivity settings which apply to a first type of cellular network such as GSM, with some instances being suitable for a home network operator, and some instances being suitable for network operators in other countries. There may be some connectivity settings which apply to a second type of cellular network such as WCDMA, with some instances being suitable for a home network operator, and some instances being suitable for network operators in other countries.

Preferably, there is an instance of one type of connectivity which is active and the connectivity settings are sent to update that particular instance with a replacement instance of that type of connectivity. Other types of connectivity settings may also be sent. However, a terminal device may have a first instance of one type of connectivity which is available for use, may receive a second instance of that type of connectivity which then becomes available for use in preference to the first instance of that type of connectivity, and then may go into a state in which the first instance of that type of connectivity becomes available for use in preference to the second instance of that type of connectivity. The second instance of that type of connectivity may then be discarded.

In one embodiment of the invention, the connectivity settings are sent in response to the activation of a calendar reminder. The connectivity settings may be sent in advance of the terminal device being at the detected location. Alternatively, the connectivity settings may be sent as a result of detecting that the terminal device is at the detected location. In one embodiment, the calendar reminder is generated as part of a travel plan being generated. The calendar reminder may be generated in a travelling planning tool. It may then be transferred to a settings tool. The settings tool may provide the connectivity settings to a terminal management server in response to the activation of the calendar reminder.

In one embodiment of the invention, sending of connectivity settings is triggered manually, for example as a consequence of a person activating a command in a web portal or sending a short message service (SMS) message to a predefined number. In another embodiment of the invention, sending of connectivity settings is triggered based on a travel reservation process progressing to a predefined stage of the process, for example: a) step 1, fill in personal information, b) step 2, fill in a travel destination, c) step 3, send connectivity settings. There may be an additional step in which a list of connectivity settings is presented as options by a travel reservation tool and particular ones of these can be accepted and chosen.

Accordingly, in one embodiment, sending the connectivity settings is triggered on a time-dependent basis and in another embodiment, sending the connectivity settings is triggered on a location-dependent basis. It will thus be understood that in the case of sending of the connectivity settings being triggered on a time-dependent basis, the detected location is a scheduled location which is other than an expected home location for the terminal device where it is expected that the terminal device will be in the future.

Preferably, the terminal device is a wireless terminal device, such as a mobile terminal device. It may be a wireless terminal device having mobile telephony capability. It may be a laptop, a device for handling email in conjunction with a company or enterprise email service, or a personal digital assistant (PDA) device.

The connectivity settings may be provided over the air-interface of a cellular mobile network. Alternatively, they may be provided via a non-cellular network, for example via an Intranet whether this be via a wired connection or wireless connection such as wireless LAN.

In one embodiment, connectivity settings are controlled, for example generated and updated, by an entity which is not a network operator and are provided to the network operator so the latter can provide them to terminal devices which have a relationship with the entity.

According to a second aspect of the invention there is provided a system configured to provide connectivity settings to a terminal device comprising a first network-based functionality configured to detect an indication about the terminal device being at a detected location other than an expected home location for the terminal device and a second network-based functionality configured to send connectivity settings to the terminal device which are appropriate to the detected location.

Preferably, the first and second network-based functionalities are embodied in first and second network elements. They may be embodied in the same network element. In one embodiment, the network element embodying the second network-based functionality and/or the same network element is a terminal management server.

Preferably, the system comprises a gateway through which connectivity settings can be sent from a network which generates and/or updates the connectivity settings to a network which delivers them. These networks may also be the same, for example a company network which has its own terminal management server.

Preferably, the system comprises a travel plan arranging sub-system. This may be under the control of an entity which is different to the entity which controls a delivery network which delivers the connectivity settings to the terminal device.

Preferably, the system comprises a settings server present in a delivery network which is capable of receiving the connectivity settings from an application in an external network and providing them to the terminal device.

According to a third aspect of the invention there is provided a network element configured to provide connectivity settings to a terminal device, the network element being configured to detect an indication about the terminal device being at a detected location other than an expected home location for the terminal device and being configured to send connectivity settings to the terminal device which are appropriate to the detected location.

According to a fourth aspect of the invention there is provided a terminal device capable of:

(i) detecting an indication about it being at a detected location other than an expected home location;
(ii) receiving connectivity settings which are appropriate to the detected location; and
(iii) applying the connectivity settings within the terminal device so that they are available for making connections.

According to a fifth aspect of the invention there is provided a computer program product comprising software code that when executed on a computing system performs a method of:

(i) detecting an indication about the terminal device being at a detected location other than an expected home location for the terminal device; and
(ii) sending connectivity settings to the terminal device which are appropriate to the detected location.

Preferably, the computer program product is stored on a computer-readable medium.

According to a sixth aspect of the invention there is provided a terminal device capable of:

(i) detecting an indication about it being at a detected location other than an expected home location;
(ii) requesting connectivity settings which are appropriate to the detected location; and
(iii) applying the connectivity settings within the terminal device so that they are available for making connections.

According to a seventh aspect of the invention there is provided a terminal device capable of:

(i) storing home location connectivity settings;
(ii) receiving, in addition, transferred connectivity settings which are appropriate to a detected location other than the home location; and
(iii) applying the transferred connectivity settings within the terminal device so that they are available for making connections.

In one aspect, the invention relates to automated connectivity and service settings provisioning. This may be done when an employee is travelling. It may facilitate the use of low cost communication types or instances of types resulting in a reduction in costs incurred by an employer and improvement in end user experience, for example service quality, in working remotely.

In another embodiment, the invention provides for the integration of connectivity and service settings provision into enterprise travelling tools to automate processes on the part of an enterprise and on the part of a network operator.

The invention provides advantages over the use of a service such as iPassConnect™ which simply enables connections to one of a number of available networks since it enables/encourages use of enterprise preferences such as—which access network to use at a certain location, whenever a company Intranet WLAN is available to use that in preference to a cellular network such as a 3G network, and when to prefer VoIP call over a circuit-switched call. It provides positive encouragement to use particular ones of available connectivity types and connections in order to reduce costs.

Embodiments of the invention will now be described, by way of example only, with reference to the accompanying drawings in which:

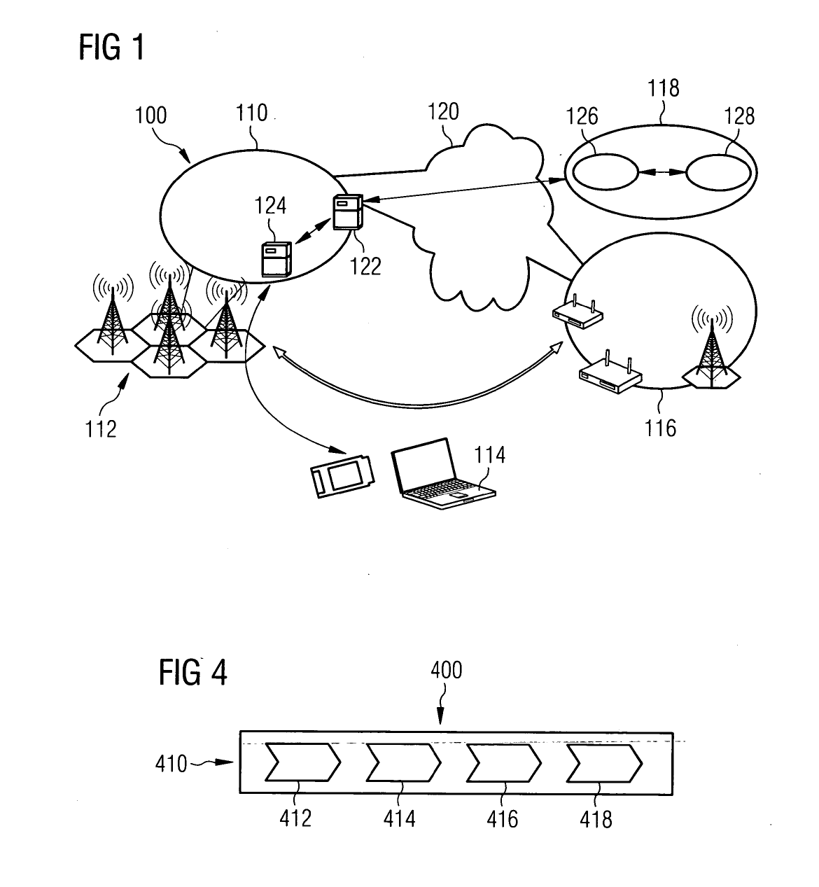

FIG. 1 shows a system; and

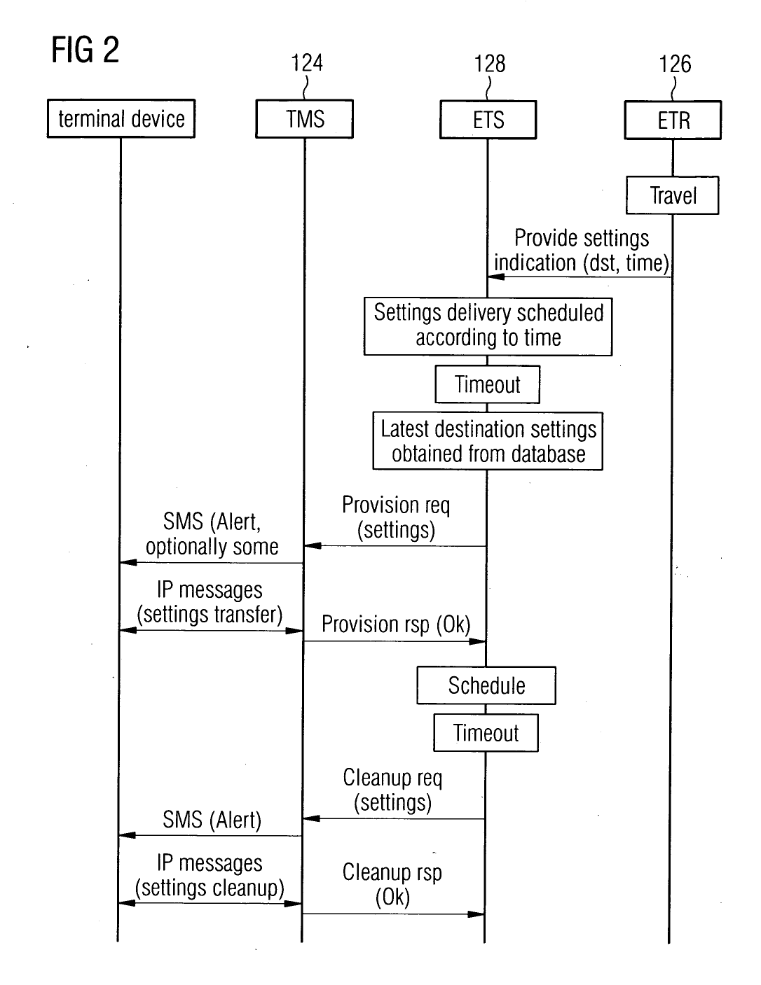

FIG. 2 shows the flow of messages according to a first embodiment;

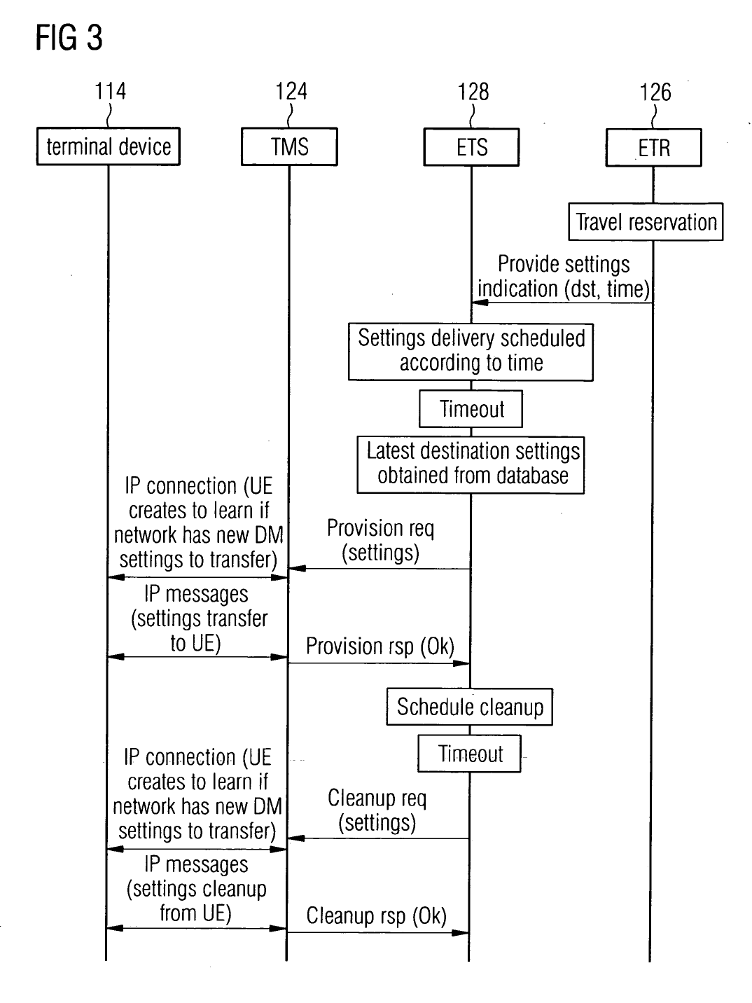

FIG. 3 shows the flow of messages according to a second embodiment; and

FIG. 4 shows an enterprise travel reservation process.

FIG. 1 shows a communications system 100 according to the invention. The communications system 100 comprises an operator core network 110, a cellular radio network 112 connected to the core network 110 and enabling connections between it and wireless terminal devices 114, non-cellular connectivity 116, in this case access points, and an enterprise application system 118 which is configured to connect to the operator core network 110 over the Internet 120. The enterprise application system 118 is under the control of an enterprise, for example a company. In this embodiment of the invention, the non-cellular connectivity 116 comprises WLAN and WiMAX access points. The Internet 120 also provides routing for data going to and from the wireless terminal devices 114 via the operator core network 110 and the non-cellular connectivity 116. The wireless terminal devices 114 may be mobile terminals, laptops, and personal digital assistants (PDAs).

The enterprise application system 118 communicates with the operator core network 110 via an enterprise gateway 122. The enterprise gateway 122 may enable secure communication between a company Intranet and an operator network for a company having a service agreement with the operator. Within the operator core network 110, the enterprise gateway 122 is able to communicate with a terminal management server (TMS) 124 which is capable of receiving and handling settings and providing them to the wireless terminal devices 114. The server 124 may comprise a network operator Open Mobile Alliance (OMA) Device Management (DM) server or a network operator Access Network Discovery and Selection Function (ANDSF) server, or both. It should be noted that an OMA DM server is provided for each cellular network controlled by a network operator. This server contains various settings, for example configuration settings which allow changes to settings and parameters of subscriber terminal devices, which can be provided to subscriber terminal devices in the network in order for them to have appropriate connectivity. An ANDSF server typically contains data management and control functionality necessary to provision network discovery and selection assistance data according to the policy of the network operators. For example, a variant of the server 124 comprises an ANDSF server which contains a set of operator-defined rules and preferences that affect the inter-system mobility decisions taken by a terminal device, indicating preferred access types, for example that WiMAX access is preferable to WLAN access and restricting handover types (for example from cellular access to WLAN access). It may provide a list of access networks available in the future travel planned vicinity of the terminal device including:
the access technology type (for example WLAN, WiMAX, and cellular).
the access network identifier (for example the SSID of a WLAN).
the PLMN(s) it provides access to (which may be presented in a prioritised order which prefers low-cost VPLMNs).
a preference value, indicating the operators preference to access a particular access network.

WLAN settings may include those to gain access to a company or an enterprise Intranet.

The rules do not have to be operator-defined. Relevant ANDSF information and rules may be provided by an enterprise, for example to determine that when a WLAN, for example SSid, of the enterprise is detected, this WLAN is used in order that the enterprise can determine the ANDSF information provided to the terminal device.

The terminal management server may include also a Subscriber Identity Module Over The Air (SIM OTA) management function to provide VPLMN selection preferences for cellular capable devices. The. SIM OTA management functionality allows the terminal management server to send operator and/or enterprise preferences for VPLMN selection. When the terminal device is roaming and selecting which VPLMN is to be used, the terminal device uses the terminal management server provided preferences. Settings for other radio technologies such as WLAN may be provided in a similar way.

Although in this embodiment of the invention, the server 124 is controlled by the operator of the network 110, in a variant of the invention, the server 124, comprising the OMA DM server and/or the ANDSF server may be controlled by the enterprise which controls the enterprise application system 118 and may even be located in an enterprise network. In such a case, the server 124 may arrange for settings to be delivered to the terminal device 114 either by the enterprise network or via the network 110.

An embodiment of the invention will now be described in which connectivity settings are provided on a time-dependent basis. In this embodiment of the invention, the enterprise application system 118 comprises a travel reservation system which is used by travel arranging personnel to make travel arrangements for employees of the enterprise (referred to in the following as travelling employees). The travel reservation system may generate a travel plan for a travelling employee's individual trip including information such as the departure and return times and dates of the trip, information about the mode of travel of the trip (for example in the case of flights, the airline(s), flight number(s), flight time(s), and flight departure and flight arrival points), destination of the trip (down to a detail level of country, town/city, or even street address), hotel reservation information, and places at which the employee will be working. The travel reservation system may also have integrated within it functionality which enables booking/reservations to be made for modes of travel, accommodation, and related activities.

It should be noted that although the word “employee” is used in this description, the invention is not limited to employees but is in fact applicable to users of terminal devices having, for some reason, the need or desire to be provided with connectivity settings which vary from a home location to another location. This could include contractors, individuals to be given temporary access such as visitors and temporary workers.

In order to provide an illustration of the invention, its operation according to one embodiment will now be described in terms of a number of steps which are carried out.

### Step 1—Travel Reservation

When an employee needs to travel, a sub-part of the enterprise application system 118 referred to as an enterprise travel reservation tool (ETR tool) 126 is used to make a travel plan (booking flight tickets, hotel, etc.). The ETR tool 126 is provided with a user interface enabling travel arranging personnel to make the appropriate arrangements and enter and transfer the appropriate travel reservation information, including the destination of the trip the travel dates, the booked hotel, and potentially used public transportation (such as trains).

### Step 2—Travel Reminder

The ETR tool 126 communicates with another sub-part of the enterprise application system 118 referred to as an enterprise travel settings tool (ETS tool) 128, and provides it with relevant travel information for the travelling employee.

The ETS tool 128 may store a calendar reminder in respect of the arranged travel plan. The arranged travel plan may include the dates of travel, for example from 05.06.2009 to 08.06.2009. The ETS tool 128 calendar reminder is configured to be in advance of the travelling dates/times, for example it may be configured to be one or two days before the planned travel date or on the same day that the travelling is to start but slightly ahead in time by a matter of minutes or hours. In one embodiment of the invention, the ETS tool 128 is configured to generate a calendar reminder which is estimated to be at a date and/or time when the travelling employee is to be in the office. Therefore, this might be the day before the travelling is to start.

### Step 3—Triggering Settings Provision

At the appropriate date and time, the calendar reminder in the ETS tool 128 is activated which triggers the ETS tool 128 to select appropriate connectivity settings for the travelling employee from a settings database (not shown). Since the settings are sent just prior to the travelling employee starting his travel, this means firstly that up-to-date settings are selected and secondly that, in the event of a trip being cancelled before the settings are sent, additional processing and communication is avoided.

The appropriate connectivity settings may include:
Country/city roaming operator preferences (preferred VPLMN information such as MCC/MNC information). This may be a preferred low-cost partner network.
Local office settings where the travelling employee has arranged to work, for example where a meeting is scheduled. This may encourage travelling employees to use an Intranet WLAN and VoIP instead of a roaming cellular connection to transfer data and to make circuit-switched voice calls. This may also encourage the use of local applications and services, such as a local virtual private network (VPN) gateway for secure connections to a company Intranet, for example when a company employee from Asia is in Europe using a local European VPN gateway instead of an Asian one thus keeping traffic as local as possible and providing cost/resource savings.
Local connectivity settings, if available, for public transportation. For example WLAN settings for a train going between an airport and a city to gain high speed access to enable email synchronization, and provide access to news sources when travelling by train.
Local connectivity settings for an arranged hotel, for example WLAN settings and optionally a pre-paid connectivity account for the duration of the travel to limit difficulties in arranging connectivity such as setting it up and dealing with payment for a connectivity service. (In case the enterprise, or an operator providing this service to an enterprise, may have an arrangement deal with a hotel chain to include their local connectivity settings, such as their WLAN settings, which may be used to obtain a favourable rate for hotel accommodation with the hotel chain.)
Reception number for a local office.
Information about services available at a local office, for example canteen information.

It will be understood that appropriate settings are selected by the ETS 128 based on the corresponding information in the travel plan including, for example, travel tickets, modes of transport, locations for accommodation, and working locations. Some of the settings may be retrieved from external databases, such as hotel access settings from a hotel server or public transportation company databases. Others of the settings which are not publicly available (or are more readily available from non-public sources) may be obtained from a database present in the enterprise application system 118, such as local enterprise office settings and roaming network operator preferences.

The server which provides the connectivity settings to the terminal management server 124, whether being part of the ETS tool 128 or otherwise, may be provided with the capability to add and/or upload connectivity parameters supplied by the employer of the employee. For example an enterprise may provide the Lightway Directory Access Protocol, running on top of TCP/IP (LDAP) to allow an external server to access a centralised enterprise settings database (to keep local settings in one place but easily accessible). It may also be provided with the capability to add and/or upload connectivity parameters supplied by various parties including an enterprise IT department, end users, and operators.

The server may be owned by an enterprise (with a network operator simply routing to and from it SMS messages and other relevant communications), it might be owned by a network operator, or it might be owned by a specialised connectivity broker. In this context, and indeed throughout this document, the term “owned by” is intended to include the concept “controlled by”.

Step 4—Transferring Settings to the Operator Domain Once the ETS tool 128 has selected one or more settings which are appropriate to the travel plan of the travelling employee, it transfers the settings to the network operator domain (via a suitable application programming interface (API)) having a hosting capability to host settings so that they can be provided to subscribers. The network operator domain may have a hosting capability which is dedicated to a particular enterprise and provides settings to employees of that enterprise. For example, local office settings are stored in a network operator OMA DM server, and 3GPP/non-3GPP access network preferences, such as preferring the use of a defined WLAN network to a cellular network, are stored in a network operator ANDSF server. The latter settings may be in the form of a prioritised list having, from most preferred to least preferred, a home WLAN, a company Intranet WLAN, an operator-controlled WLAN, and a cellular network
Step 5—Settings Provision to the Employee Once the ETS tool 128 has provided settings for the travelling employee, the relevant network elements (such as an OMA DM server) provide the settings for the terminal device of the employee.

Preferably settings provision is made prior to employee travelling, in order to provide the employee with a seamless connectivity experience, and allow him to make desired connections immediately on arriving at a destination location. An advantage of this approach is that settings can be provisioned by convenient and/or low cost communication modes such as being sent within a home cellular network, within an enterprise Intranet, or via a WLAN access point. This avoids the cost and potential difficulties which might be incurred in provisioning settings to a terminal device outside of its home network, for example roaming in another network.

The system generally operates to provision settings for a trip in which the travelling employee leaves a home area or country, goes to a visited area or country, and then returns home. However, the system may also operate to provision settings for a trip in which the travelling employee leaves a home area or country, goes to a first visited area or country, then goes to a second visited area or country, and then returns home. In this case, the system will provide the terminal device with two sets of settings, a first set for the first visited area or country, and a second set for the second visited area or country. (Additional sets of settings for additional countries may be provided as necessary, either automatically by an enterprise or an operator network or as requested by a user or a terminal device.) In such a case, the terminal device is itself able to put the first set of settings into operation and then replaces them with the second set. This replacement may be triggered by such things as an internal calendar reminder or by detecting a change in the communication environment (for example available access networks match to a set of settings contained in the terminal device or an IP address allocated to the terminal device matches a defined sub-net indicating a particular country).

### Step 6—Using the Settings

The terminal device applies the received settings. In a preferred embodiment of the invention, the settings are not applied in the terminal device immediately on receipt but instead are configured to be applied at some future point when they are ready to be put into use. They may mean, for example, that currently used settings are not replaced with settings suitable for use in another location or country thus preventing connectivity based on the currently used settings.

### Step 7—Clean-Up

As an option to avoid using old settings or taking up memory unnecessarily, settings previously provided may be removed once a trip has been completed. For example, a network operator OMA DM server which has provided settings may also cooperate with the terminal device to perform a delete operation to remove them from the memory of the terminal device.

Clean-up can be triggered automatically by the ETS tool 128 immediately after a trip is scheduled to have ended, or one to two days after its scheduled end. For example when the planned travel dates are 05.06.2009 to 08.06.2009, the ETS tool 128 may trigger a clean-up operation on 09.06.2009. Alternatively, a clean-up operation may not be triggered by a calendar reminder but is instead initiated when the terminal device recognises that is back within its home network. This may involve a network sending a policy to the terminal device that when returning to the home network so that either the HPLMN or home office WLAN network is recognised as being available, the travelling connectivity settings are removed and using home connectivity settings is re-commenced.

As an option, the ETS tool 128 may provide a time stamp to the network operator domain in order that network operator tools are used to perform a clean-up operation. Instead of the clean-up trigger coming from the ETS tool 128, network operator tools, such as the OMA DM server, use the time stamp to determine when to schedule the clean-up operation.

In an alternative embodiment of the invention, it is possible for a communications system to provide settings to a travelling employee once they have arrived at a destination in a way which is independent of any calendar/travel plan information (that is, not on a time-dependent basis). This can be a location-dependent connectivity settings provisioning service. For example, in the case of an employee's terminal device operating in a visited cellular network in cellular mode, it makes a location update which is received by a home location register (HLR) in its home cellular network, and in response, an appropriate settings hosting server in the home cellular network can send enterprise settings provision to the travelling employee's terminal device. This can happen either at the initiative of the terminal device or at the initiative of a network element. In the former case, the terminal device when switched on is configured to contact the terminal management server 124 in its home network, the terminal management server 124 determines from this contact whether the terminal device is roaming, determines where it is roaming, and then sends suitable settings. Therefore, the HLR does not have to be modified. In the latter case, on receiving a location update, the HLR is able to determine if the terminal device is roaming and if so, checks the subscription of the terminal device to determine whether it is one for which particular settings are to be provided in this eventuality (for example it is an enterprise subscriber). If this is the case, the HLR sends to the terminal management server 124 information indicating, according to the location update, the location of the terminal device along with an identity of a user or of the terminal device (or similar). This can be, for example, the HLR sending to the terminal management server 124 relevant network identification code information, for example MCC/MNC information or information based on a network element address (such as a signalling point code address or an IP address). As a result, the terminal management server 124 sends to the terminal device correct connectivity settings for its current location. The terminal management server 124 may send settings which have previously been stored or it may request settings from the ETS tool 128. In the latter case the terminal management server 124 contacts the ETS tool 128 and may indicate location information and user and/or terminal device identification information to receive appropriate settings to be transmitted to the terminal device.

In an alternative location-dependent provisioning system, a network element in a VPLMN may trigger provision of local connectivity settings to the terminal device. For example after a terminal device has been switched on and attempts to register with a VPLMN, the Visiting Location Register (VLR) in the VPLMN receives location update message sent by the terminal device to connect to the cellular network. The VLR may determine, in a way which is similar to that carried out by the HLR described in the foregoing (for example based on information provided by the terminal device or by the HLR), that this is an enterprise terminal device for which local connectivity settings need to be provided, and, as a result, trigger the provision of such settings, for example via the terminal management server 124 in the home network of the terminal device.

Such a location-dependent provisioning approach can be modified to apply to the situation in which the employee's terminal device operates in non-cellular mode in a visited non-cellular network. In such a system, the terminal device 114 contacts the terminal management server 124 to request appropriate connectivity settings, the terminal management server 124 is able to determine if it is in a location for which settings have to be provided, for example by receiving from the terminal device location information such as global positioning system (GPS) or appropriate network element identification information, and provides appropriate connectivity settings. Alternatively, rather than settings being provided as a result of an act performed by the terminal device, the terminal management server 124 determines, by using appropriate address information such as an IP address, that the terminal device is roaming and accordingly provides appropriate connectivity settings.

In this embodiment it is possible to configure the OMA DM server so that it contains connectivity settings that are likely to be required (in terms of locations, countries, different connectivity types and instances) and it is not necessary for an enterprise application system 118 to be present. However, if some of the enterprise settings are private and/or changeable, it might be convenient for these settings to be contained in an enterprise application system 118 and be provided in response to a request via the enterprise gateway 122 being received.

In one embodiment, the terminal device comprises functionality which enables it to examine connectivity-related factors such as MCC/MNC, IP address range (for example 132.100.XXX.XXX), WLAN SSid, WiMAX network id, and, on identifying that the terminal devices is away from a home location, to trigger it to contact the terminal management server 124 to request for connectivity settings appropriate to the current location. For example, when the terminal device enters a country and detects a particular VPLMN MCC, the terminal device asks for local settings and the terminal management server provides them (optionally with the assistance of the ETS tool 128). This enables the terminal device to use an appropriate set of settings.

It should be understood that in an embodiment based on location-dependent connectivity settings provisioning, it is not necessary for a travel-related tool such as an enterprise travel reservation tool (ETR tool) or an enterprise travel settings tool (ETS tool) to be involved in sending settings to a terminal device. It can also be time-independent, that is not calendar based. Instead, the relevant network element notifies an OMA DM server or other appropriate server, which, having been informed that the terminal device is, for example, in another country, obtains relevant settings and sends them automatically. Of course, although this is more convenient, one disadvantage location-dependent provisioning has when compared to the embodiment based on a travel arranging/reservation system is that the travel-related tools described in the foregoing provide a convenient way of allowing the provision of settings to happen in the background simply by responding to a travel plan and the settings can be sent locally, for example over a local area network in the employee's dedicated office location and it is not necessary to have to pay any charges to transmit the settings. This may reduce the amount of expensive roaming charges incurred by a company or enterprise. Furthermore, the settings are already present in the terminal device on arrival at the destination and can be immediate put to use on arrival without it being necessary for any configuration to occur which can cause delays or a failure to establish a connection properly.

In an embodiment of the invention in which the connectivity settings provisioning is location-dependent rather than time-dependent, it is not restricted to connectivity settings being provided to terminal devices being used by employees of a company or an enterprise or other individuals having an association with such an entity, but may be provided to terminal devices being used by normal subscribers of a network operator. For example, when such a subscriber is going away to a destination where there will be no access to a HPLMN but there will be access to a VPLMN, the user may be able to send an SMS message to a predefined number with destination information or to use network operator web portal to provide such information to a network operator. Receipt of the information in whichever way may trigger connectivity settings being provisioned which are appropriate to the destination. In such a case, a home network operator is able to facilitate use of a low-cost VPLMN partner at the destination.

The steps described in relation to time-dependent connectivity settings provisioning are further explained with reference to FIG. 2 which shows the flow of messages according to a first embodiment in which settings provision is done via a cellular network.

Generation of a travel plan starts the procedure. This causes the ETR tool 126 to send a “Provide settings indication” message (including information such as destination and start and end times of the travel plan) to the ETS tool 128 which in time will trigger settings provision to a travelling employee's terminal device.

The terminal device may be provided with appropriate intelligence to determine when connectivity settings are to be put into use by detecting:

(i) that it is not in a home location such as when a PLMN other than the HPLMN is detected;
(ii) when a particular time has been reached;
(iii) when a network having a particular ID (such as the VPLMN ID or WLAN SSID) is detected;
(iv) when the currently used (email or similar) server in a home office Intranet is no longer reachable; and/or
(v) when an IP address allocated to the terminal device belongs to a specified IP address range, for example being between 132.100.AAA.BBB and 132.100.CCC.DDD.

The most up-to-date settings (containing local destination settings and preferences) are obtained by the ETS tool 128 from a settings database. Once the settings have been obtained, a “Provision request” message is sent to the terminal management server 124 to request settings provision to the terminal device 114. The terminal management server 124 sends an Alert SMS to trigger the terminal device 114 to initiate an IP connection between the terminal management server 124 and the terminal device 114. Settings and preferences are transferred to the terminal device 114 using the IP connection (for example by transferring HTTP messages). In case only a small amount of settings need to be transferred, these can be transferred in the SMS message without it being necessary to establish an IP connection (to the terminal management server 124). After delivering the settings to the terminal device 114, a “Provision Response (OK)” message is sent to ETS tool 128 confirming settings delivery.

Optionally the ETS 128 schedules a clean-up operation to avoid filling up available memory in the terminal device 114 with out-of-date settings which are no longer needed. In this case, after a timeout the ETS tool 128 requests the clean-up operation for the provided settings causing the terminal management server 124 to effect their removal from the terminal device 114.

As an option, also terminal management server 124 may contain a scheduling function. In this case the ETS tool 128 sends settings and schedule information to the terminal management server 124 and according to this, the terminal management server 124 takes care of settings delivery (immediately or later) and optionally also automatically arranges a settings clean-up operation.

Clean-up may be effected by providing connectivity settings with “valid between” or “valid until” time stamps which enable their automatic removal by the terminal device or the terminal management server 124. It is convenient for this information to be maintained at the terminal management server 124. However, if this information is provided as part of a connectivity settings profile, this allows the terminal device to be able to remove it with assistance from the terminal management server 124.

FIG. 3 shows the flow of messages according to a second embodiment in which settings provision is done via a non-cellular network. The flow of messages is similar to those sent and received in FIG. 2 and so, rather than repeating descriptions of similar message exchange, the differences will be identified. Once the terminal management server 124 has received the connectivity settings, for example provided as a result of a calendar reminder, rather than sending an Alert SMS to the terminal device, the terminal management server 124 waits until it is contacted by the terminal device at some subsequent point, and then transfers the settings to the terminal device using an IP connection. In addition, a clean-up operation is requested by the ETS tool 128 in respect of the provided settings when the terminal device 114 contacts the terminal management server 124 at a subsequent point in time, causing the terminal management server 124 to remove the settings from the terminal device 114.

The invention is also described with reference to FIG. 4. This shows an enterprise travel reservation process 400 in which connectivity settings are sent as a result of the process reaching a specific stage. At the start of the process 410, a travelling employee needs to go on a trip and a travel plan is created using an enterprise application system which may comprise a web portal and associated IT back-end system. In step 412, the travelling employee is authenticated and personal details and travel information, including the travel destination, are entered into the system. In step 414, appropriate connectivity settings are obtained (provided by an ETS tool) to match the information entered in step 412. In step 418, there is a clean-up operation, for example removing connectivity settings in respect of a travel plan which has been completed. Steps 414 and 416 may be carried out by a party other than the enterprise. For example the system may comprise an ETS tool owned by a network operator or other party.

The invention may be implemented in other ways. In another embodiment, an employee makes a travel plan to travel from his home country to a first foreign country and then return. According to the invention, the terminal device of the employee is provided with settings which are appropriate for use in the first foreign country before the trip begins. While the employee is in the first foreign country, his travel plan is changed so he is to travel from the first foreign country to a second foreign country and then return to his home country. In this case, his employer, via the ETR tool, provides information to the home network operator and connectivity settings which are appropriate to the second foreign country are provided to the employee before he travels to the second foreign country. This may be done, for example, by an SMS message being sent to the employee's terminal device notifying him of appropriate settings. Once the SMS message is accepted, an IP connection is established between the terminal device and the settings servers in the employee's home network and they are downloaded (in case settings were not suitable for delivery by an SMS message).

The receipt of a new set of connectivity settings does not automatically mean that an already stored set is deleted or replaced. For example, there may be a home set which is not replaced with a travelling set. A frequently used travelling set may be retained for re-use at some point in the future.

Connectivity settings appropriate to a particular travel destination may be scheduled to be sent from the ETS tool 128 to the terminal management server 124 either immediately after they have been obtained by the ETS tool 128 or a delay may be deliberately introduced. The delay may be provided by the ETS tool 128 having a timer which it sets running and then send the settings when the timer reaches a predetermined point. Alternatively or additionally, the settings may be scheduled to be sent from the terminal management server 124 to the terminal device either immediately after they have been obtained by the terminal management server 124 or a delay may be deliberately introduced. The delay may be provided by the terminal management server 124 having a timer which it sets running and then send the settings when the timer reaches a predetermined point. In one embodiment of the invention, both the ETS tool 128 and the terminal management server 124 have their own independent timers so that the connectivity settings spend some time in both before they are eventually sent to the terminal device. In another embodiment of the invention, the ETS tool 128 may deliver the settings to the terminal management server 124 together with scheduling information. In this case a timer in the terminal management server 124 is set running and the settings are sent when the timer reaches a predetermined point.

Sending settings immediately may be employed in a system employing location-dependent connectivity settings provisioning. Sending settings after a timer reaches a predetermined point may be employed in a system employing time-dependent connectivity settings provisioning.

Although in the foregoing there is discussion of the terminal device being in a country other than a home country, the invention is applicable to the terminal device being in a home country but in a location within the home country that is other than an expected or normal home location. For example, the terminal device might be in a different office location to a normal one, such as on another site, or it might be used by a user working from a hotel or a conference location. In such cases, appropriate connectivity settings may be provided for those locations.

While preferred embodiments of the invention have been shown and described, it will be understood that such embodiments are described by way of example only. For example, in an implemented form, the defined steps described in the foregoing may be combined or done in a different order to that presented. Numerous variations, changes and substitutions will occur to those skilled in the art without departing from the scope of the present invention. Accordingly, it is intended that the following claims cover all such variations or equivalents as fall within the spirit and the scope of the invention.

1. A method of providing connectivity settings to a terminal device comprising the steps of:
(i) detecting an indication about the terminal device being at a detected location other than an expected home location for the terminal device; and
(ii) sending connectivity settings to the terminal device which are appropriate to the detected location.

2. A method according to claim 1 in which the connectivity settings include settings in respect of a connectivity type which is different to the connectivity type via which the terminal device communicates with a network element in receiving the connectivity settings.

3. A method according to claim 1 in which the connectivity settings are sent from a network element located within and/or under the control of a network operator.

4. A method according to claim 1 in which the connectivity settings are sent from a network element under the control of a company or enterprise which is separate to the network operator.

5. A method according to claim 1 in which the connectivity settings are specific to a company or enterprise.

6. A method according to claim 1 in which sending the connectivity settings is triggered on a time-dependent basis.

7. A method according to claim 1 in which the connectivity settings are sent in response to the activation of a calendar reminder.

8. A method according to claim 7 in which the calendar reminder is generated as part of a travel plan being generated.

9. A method according to claim 7 in which the calendar reminder is generated in a travelling planning tool and then transferred to a settings tool which provides the connectivity settings to a terminal management server in response to the activation of the calendar reminder.

10. A method according to claim 7 in which the connectivity settings are sent in advance of the terminal device being at the detected location.

11. A method according to claim 1 in which sending the connectivity settings is triggered on a location-dependent basis.

12. A method according to claim 1 in which the connectivity settings are sent as a result of detecting that the terminal device is at the detected location.

13. A method according to claim 7 in which the home location is the terminal device's network to which it has a subscription and/or access rights.

14. A method according to claim 7 in which the terminal device is a wireless terminal device.

15. A system configured to provide connectivity settings to a terminal device comprising a first network-based functionality configured to detect an indication about the terminal device being at a detected location other than an expected home location for the terminal device and a second network-based functionality configured to send connectivity settings to the terminal device which are appropriate to the detected location.

16. A system according to claim 15 comprising a gateway through which connectivity settings can be sent from a network which generates and/or updates them to a network which delivers them.

17. A network element configured to provide connectivity settings to a terminal device, the network element being configured to detect an indication about the terminal device being at a detected location other than an expected home location for the terminal device and being configured to send connectivity settings to the terminal device which are appropriate to the detected location.

18. A terminal device capable of:
(i) detecting an indication about it being at a detected location other than an expected home location;
(ii) receiving connectivity settings which are appropriate to the detected location; and
(iii) applying the connectivity settings within the terminal device so that they are available for making connections.

19. A computer program product comprising software code that when executed on a computing system performs a method of:
(i) detecting an indication about the terminal device being at a detected location other than an expected home location for the terminal device; and
(ii) sending connectivity settings to the terminal device which are appropriate to the detected location.

20. A computer program product according to claim 19 in which computer program product is stored on a computer-readable medium.
